(19) United States
(12) Patent Application Publication
(10) Pub. No.: US 2022/0252514 A1
(43) Pub. Date: Aug. 11, 2022

(54) FLUORESCENT SOLID-STATE MATERIALS FOR OPTICAL CALIBRATION AND METHODS THEREOF

(71) Applicant: Star Voltaic, LLC, Indianapolis, IN (US)

(72) Inventor: CHRISTOPHER RYAN BENSON, Indianapolis, IN (US)

(21) Appl. No.: 17/669,311

(22) Filed: Feb. 10, 2022

Related U.S. Application Data
(60) Provisional application No. 63/147,825, filed on Feb. 10, 2021.

(51) Int. Cl. G01N 21/64; C09B 23/04

(52) U.S. Cl. CPC G01N 21/6458; G01N 2201/12746; G01N 2021/6441; C09B 23/04

(57) ABSTRACT

A method for calibrating scientific instrumentation or light utilizing instrumentation utilizing one or more small-molecule, ionic isolation lattice (“SMILES”) composites for use as calibration targets for a scientific instrument, such as a fluorescent microscope. The SMILES composite can include a dye element, a couterion element, and a receptor element. In some exemplary embodiments, the SMILES composite can include the following formula: a (dye^{m+})ₓ.(counterionⁿ⁻)_{y}.(receptor)_{z}, wherein values of m, n, x and y may be integers greater than or equal to 1. The materials derived from these SMILES elements may be prepared as crystals (about >1000 nm diameter), microparticles (between about 1000-300 nm diameter), nanoparticles (between about 300-1 nm diameter), and dispersions in polymers or solution (dyes are monomolecular or ion-paired) or neat films of any thickness (no added polymer).

### CROSS-REFERENCE TO RELATED APPLICATION

This U.S. patent application claims priority to U.S. Provisional Application 63/147,825 filed Feb. 10, 2021, the disclosure of which is considered part of the disclosure of this application and is hereby incorporated by reference in its entirety.

### FIELD OF THE INVENTION

This invention relates generally to materials, tools, and methods for calibration of scientific instrumentation, fluorescent diagnostic tests, or other light based technologies. In one aspect, the present disclosure relates to small-molecule, ionic isolation lattices (“SMILES”) for use in calibrating scientific instrumentation and/or instruments utilizing light technologies.

### BACKGROUND

Fluorescence is a commonly used and highly sensitive signal for a number of high tech and scientific instrumentation applications (medical diagnostics, environmental monitoring, etc.). At the heart of this signal are fluorescent molecules, which are distinguished by their ability to absorb one (or more) wavelengths of light and convert it into another (generally longer) wavelength. This conversion of light from one wavelength to another is the result of a photochemical excitation/relaxation cycle and is a sufficiently rare phenomenon that the fluorescent material may be identified by its characteristic response to light.

In practice, fluorescence is used to study molecules or molecular processes. In this capacity, fluorescence can be analogized to a kind of molecular radar; light is transmitted into a sample and the signal that returns from the sample is captured and decoded by a receiver. Fluorescent molecules (or more often, a molecular probe functionalized with a fluorescent molecule) are applied to a sample then irradiated by a light source that excites the fluorescent molecules inside the sample. The response of the sample to this incident light provides information about the environment around the fluorescent molecules, which can then be interpreted qualitatively (e.g., presence or absence of fluorescence emission) or quantitatively (e.g., intensity of emission, spectral features of the emitted light). Fluorescence is an efficient enough process that a large dynamic range of detection can be realized (sub-nanomolar concentrations). This fact, along with the relative ease of engineering fluorescence-detecting instrumentation and the continuously decreasing costs of their components (LEDs, photodetectors, etc.) have made fluorescence a ubiquitous tool in biological, medical, and chemical science.

A simple example of this technique is in the testing for the presence of nitrates within cells as reported by Fatima et al. (see Fatima, U. et al., ACS Omega 2020, 5, 46, 30306). In this instance, a nitrate-sensitive “nanosensor” is expressed inside a living cell. In the absence of nitrate, the sensor absorbs violet light and emits blue light. However, when nitrate in present, it will bind to the nanosensor, altering the fluorescence properties of the sensor and causing it to emit green light. The measurements are taken by an instrument for known as a fluorimeter which uses a light source (e.g., an LED) to illuminate the sample mixture and a photosensitive detector (e.g., a charge-coupled device, or CCD, camera) to monitor the response. Filters or other optical components (e.g., monochrometers, mirrors, lenses, etc.) may also be used in the instrument. A software program utilized by the instrument can then convert the stimulus-response process into a data output. In circumstances like the example described above, where the sensor is “ratiometric”, quantification of the analyte concentration (i.e., nitrate) may be achieved. Similar efforts could be deployed to detect nitrates in water supplies (to ensure water potability) or soil (to enable real-time monitoring of fertilizers on farmland).

In summary, through the use of fluorescence emitted light can be used to gauge the presence or absence of a compound of interest, and in some cases its relative abundance in the sample. When the presence or quantity of a compound of interest can be correlated to a disease, this technique may be used to aid medical diagnosis.

However, a significant problem with fluorimetry arises with the interpretation of the output signal. The hardware and manufacturing involved in fluorimeters show degrees of variability which means different instruments would report different results for identical samples. In essence, the output signal is intrinsically corrupt because it's not clear whether variables in the hardware are contributing erroneous information to the result. Ambiguity makes it impossible to obtain fully accurate results. A corollary problem is that every instrument is slightly different than other “identical” instruments due to its own unique set of variable components, which makes data comparisons between instruments dubious. As mentioned above, fluorescence techniques are highly sensitive, which means that slight variations can have significant impacts on the resulting data. Moreover, the light output measured by the instrument must be put in context in order to provide useful information—the presence/absence or intensity of emitted light alone may not be informative on its own.

The solution to these problems is to introduce external standards with a prescribed set of unchanging properties against which the instrument can be measured and compared. With an external standard, any deviation from this baseline measurement can be attributed to variability within the instrument and can be corrected. Put another way, the external standard is used as a tool to calibrate the instrument. These samples can also provide the necessary context for the instrument software that allow them to convert a measurement into an output (i.e., a sample that is X % brighter than the external standard correlates to an analyte concentration of Y). A good analogy is to imagine tuning a musical instrument. The fluorimeter is like a piano, and the calibrant is the tuning fork: It's an agreed-upon, objective tool that allows the instrument to work properly and also allows it to harmonize with other instruments. And in the same way that tuning forks are a necessary part of music, calibrants (and calibration) are necessary for fluorescence measurement.

The ideal calibrant would mimic the emission properties of a typical sample being used in the instrument (a “calibration target”), almost always a fluorescent dye, and a variety of methods can be used for calibration. Most commonly, liquid solutions of fluorescent dyes can be prepared that serve as external standards. However, these samples are subject to errors in preparation, are prone to rapid photobleaching, add additional effort and time to the calibration process, require specialized storage conditions, and in some cases are poorly compatible with the system being calibrated. Solid calibrants, which in contrast to liquids would be reusable, consistent, robust, and hassle-free, are desirable but the creation of fluorescent dye-tinted solids is not a trivial challenge. An exemplary design for a solid state calibrant would be the introduction of a fluorescent dye that matches the sample dye into a polymer host, but the well-known issues of fluorophore solubility, concentration quenching, and solvatochromic effects induced by the polymer phase make this impractical or impossible.

Therefore, there exists a need for materials that reproduce the optical properties of calibration target solutions while embodying the material in a solid phase. Furthermore, there exists a need to utilize those materials as calibrants for optical device calibration.

Addressing this first need, Small-Molecule Ionic Isolation Lattices, (known as SMILES) are an organic materials platform that do not suffer from these aforementioned issues associated with introducing fluorescent dyes into the solid state. SMILES are formed by the spontaneous self-assembly of charged molecules (usually fluorescent dyes), their counterions, and a suitable counterion receptor (see Benson, C. R. et al. Chem. 2020, 6, 1978). This self-assembly process occurs in a charge-by-charge manner, primarily driven by ion pairing (i.e., Coulombic forces) which forecloses the formation of the dye aggregates that result in chromatic aberrations or fluorescence quenching. Instead, the self-assembly process assures that dyes are physically separated from one another and spatially isolated, similar to the spatial isolation achieved when dyes are dissolved in solvent. As such, the fundamental feature of SMILES is the ability to reproduce the solution-phase optical properties of fluorescent dyes in the solid state, with or without an associated polymer host. SMILES have been disclosed in various previous patents including PCT/US2019/021518 which is incorporated herein by reference. Addressing the second need, methods and formulations have been developed that in combination with other components and elements could be used to create solid-state calibrants for use in calibrating certain optical/light devices. The disclosures and claims made in this document relate the means by which this need can be addressed.

### BRIEF SUMMARY OF THE INVENTION

In one aspect, this disclosure is related to a method for calibrating scientific instruments, devices, or analytical tools that operate by utilizing the principle of fluorescence or other light-utilizing instrumentation or devices through the use of fluorescent solids composed of, or containing, Small Molecule Ionic Isolation Lattices, or SMILES.

The method including the use of one or more SMILES-host composite mixtures for use as calibration targets for scientific instruments, devices, or analytical tools that operate by utilizing the principle of fluorescence or other light-utilizing instrumentation or devices.

In another aspect, this disclosure is related to materials and a method for dispersing in a host material, including but not limited to a polymer, for use in calibrating scientific instruments, devices, or analytical tools that operate by utilizing the principle of fluorescence or other light-utilizing instrumentation or devices.

In another aspect, the present disclosure relates to SMILES-host composite compositions for use as calibration targets for scientific instruments, devices, or analytical tools that operate by utilizing the principle of fluorescence or other light-utilizing instrumentation or devices.

In another aspect, the present disclosure relates to the use of Small Molecule Ionic Isolation Lattices as an external standard for the calibration of light-based scientific instruments, devices, or other technologies and strategies or methods for materials development thereof.

In another aspect, the present disclosure relates to a method for calibrating light-based scientific instruments by first establishing a calibration target. A solid-state fluorescent calibration composite can be provided to reproduce the optical properties of the calibration target in a solid phase. The solid state-fluorescent calibration composite comprises one or more of the following a small-molecule, ionic isolation lattices (“SMILES”) element or a host element.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### DESCRIPTION OF DRAWINGS

FIG. 1 is an Illustration of exemplary SMILES material using counter anion receptors.

FIG. 2 are illustrations of various exemplary embodiments of dyes that may be used in SMILES compound.

FIG. 3 is an illustration of exemplary embodiments of a substitution of a dye that is incompatible with a SMILES lattice with a structural analogue.

FIG. 4 is a graphical illustration showing the tunability of fluorescence emission wavelength as a function of SMILES concentration.

FIG. 5 is a graphical illustration the spectral differences between and exemplary SMILES films prepared with polycarbonate and an exemplary embodiment utilizing a poly (methylmethacrylate) (“PMMA”) under identical concentration and processing conditions.

FIG. 6 is a graph illustrating of an absorption and emission spectra of an exemplary embodiment of a SYBR Green calibration of the present disclosure. (Black trace: Absorption spectrum; dotted trace: emission spectrum)

FIG. 7 is a graphical illustration of an absorption and emission spectra of an exemplary embodiments of a cyanine SMILES calibrant prepared with polystyrene of the present disclosure. (Black trace: Absorption spectrum; dotted trace: emission spectrum)

FIG. 8 is a graphical illustration of an absorption and emission spectra of an exemplary embodiment of a cyanine SMILES calibrant prepared with polycarbonate, notably blue-shifted relative to polystyrene. (Black trace: Absorption spectrum; dotted trace: emission spectrum)

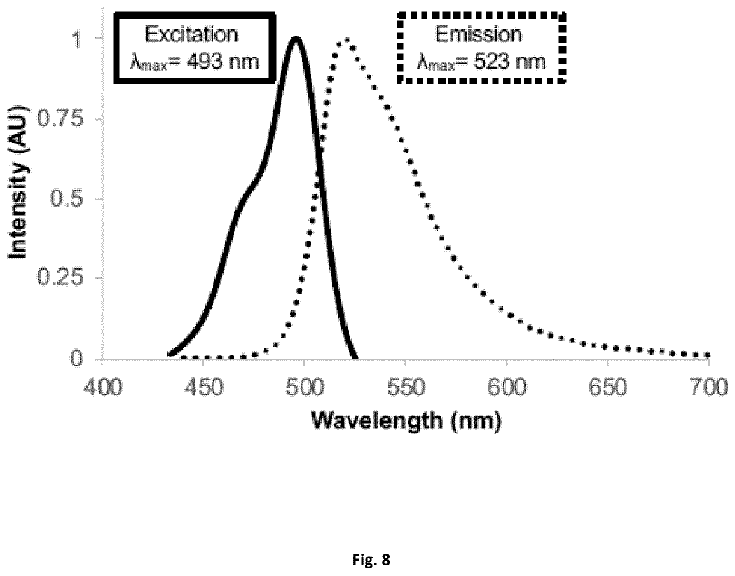

FIG. 9 is a graphical illustration showing changes in fluorescence emission intensity as a function of cyanine fluorophore concentration in a thin film of an exemplary embodiment of a calibrant of the present disclosure. (Black trace: Cyanine dye alone; dotted trace: Cyanine SMILES)

FIG. 10 is a graphical overlay of the absorption and emission spectra of an exemplary embodiment of an SYBR Green and the SMILES thin film calibrant showing significant agreement in spectral properties. (Black traces (A): SYBR Green spectra; gray traces (B): SMILES spectra; solid traces (C): Absorption spectra; dotted traces (D): Emission spectrum)

### DETAILED DESCRIPTION OF THE INVENTION

The following detailed description includes references to the accompanying drawings, which forms a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention of this disclosure is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “exemplary”, “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful and is not intended to exclude other embodiments from the scope of the invention.

As used herein, the term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

The present disclosure provides materials including Small-Molecule Ionic Isolation Lattices (SMILES) that can be integrated into a host element to form calibrants that can be used for calibrating various types of scientific instruments. To formulate a suitable calibrant, a series of strategic manipulations are made to design or program the optical properties of the final SMILES-tinted calibrant to match the optical properties of the desired target. These manipulations break down into two broad categories: Coarse adjustments and fine adjustments.

In this context, “coarse adjustments” are those that determine the fundamental spectral properties of the material (i.e., absorption and emission bands). This is principally determined through the choice of the fluorescent dye guest (or guests in the instance of compositions utilizing Förster resonance energy transfer phenomena) in the SMILES lattice. Alternately, “fine adjustments” are used to manipulate these fundamental spectral features in a more subtle way (e.g., hypsochromic or bathochromic shifts of absorption and/or emission bands, full width at half maximum of absorption and/or emission spectra, relative emission intensity, transparency, polarization of emitted light, and fluorescence quantum yield). The description that follows will enumerate some of the manipulations used, and the ways in which these manipulations impact the resulting spectral properties.

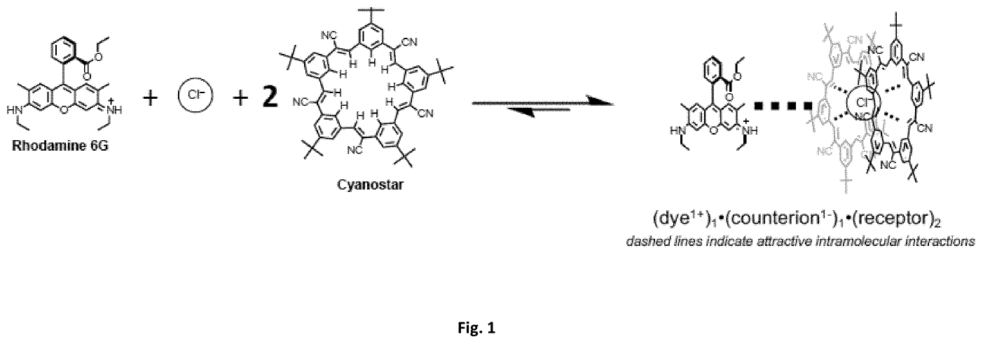

In some exemplary embodiments, the SMILES element can be selected from a group of compounds having at least one of various formulas. One exemplary embodiment of a SMILES element can include a (dye^{m+})ₓ.(counterionⁿ⁻)_{y}.(receptor)_{z}, wherein the dye^{m+} is a cationic dye, the counterionⁿ⁻ is an anion, and the counterion receptor is a binding ligand for the countenonⁿ⁻ as illustrated in FIG. 1. The values of m, n, x and y may be integers greater than or equal to 1. Another exemplary embodiment of a SMILES element can include a (dye^{m-})ₓ.(counterionⁿ⁺)_{y}.(counterion receptor)_{z}, wherein the charged dye^{m-} is an anionic dye, the counterionⁿ⁺ is a cation, and counterion receptor is a binding ligand for counterionⁿ⁺. The values of m, n, x and y may be integers greater than or equal to 1. The materials derived from these SMILES elements may be prepared as crystals (about >1000 nm diameter), microparticles (between about 1000-300 nm diameter), nanoparticles (between about 300-1 nm diameter), and dispersions in polymers or solution (dyes are monomolecular or ion-paired) or neat films of any thickness (no added polymer). These crystals, microparticles, nanoparticles, dispersions or films may be applied directly to a suitable substrate (e.g., microscope slide, cuvette) or incorporated into a host material to render the final morphology of the calibrant.

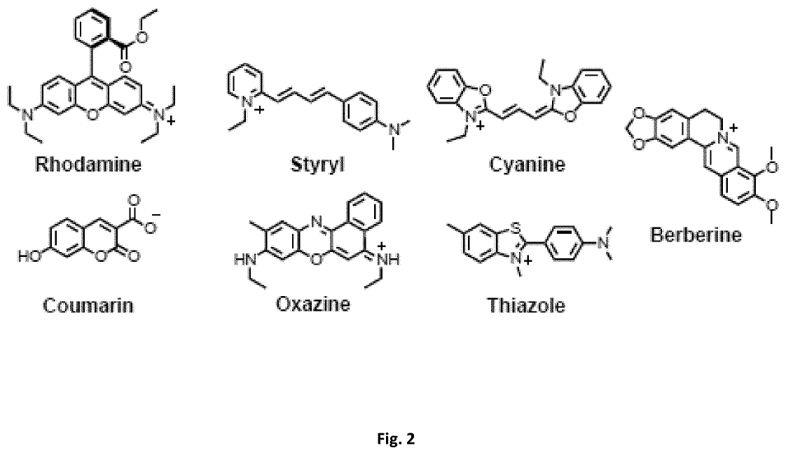

In some exemplary embodiments, a charged dye element can be any molecule bearing one or more positive or negative charges and an accompanying counterion. FIG. 2 illustrates some exemplary embodiments of dyes that can be utilized. Additionally, some exemplary dyes can be members of major classes of fluorescent dye, such as xanthine, oxazine, rhodamine, styryl, cyanine, thiazole, coumarin, dipyrromethene etc. as well as fluorescent molecules not commonly considered dyes (e.g., derivatives of pyrene), aggregation-induced emission fluorophores (e.g., berberine chloride) and derivatives of neutral molecules where a charge is introduced by chemical modification familiar to those skilled in the art such as acid/base chemistry, alkylation, quaternization of amines, etc. (e.g., addition of hydrochloric acid to neutral fluorescein molecule to produce a fluorescein chloride salt).

The host element material may be any suitable solid or liquid material. Some exemplary solid host elements can include polymers (e.g., polystyrene, polycarbonate, polyurethane etc.), gels (e.g., aqueous gels, organogels, sol gels, etc.), glasses, neat films, etc. deposited in or on a suitable substrate. In some embodiments, examples of substrates may include glass slides, polymer, glass, or metallic sample holders/cartridges/cuvettes, and 3-D printed components. Some exemplary embodiments of liquid hosts can include, but are not limited to, organic solvents (e.g., pentane, isopropanol, acetone, etc.) and aqueous solutions (including water, surfactant- and buffer-stabilized aqueous solutions and mixtures of water with soluble organic solvents).

The initial selection of a dye component in various embodiments can be the most determinative component of the resulting optical properties of the calibrant composition, and can thus regarded as a “coarse adjustment”. The choice of dye component can be made depending upon which of the following three factors that apply to the calibration target molecule. A first factor can be whether a target molecule that is compatible with the SMILES lattice. A second factor can be whether a target molecule that is incompatible with the SMILES lattice, but for which a closely related compound to the calibration target that is compatible with the SMILES lattice is available. A third factor can be whether a target molecule that is incompatible with the SMILES lattice and for which no closely related compound that is compatible for the SMILES is available.

In the first case, where the calibration target is a dye component that is compatible with the SMILES lattice (such as Rhodamine 6G chloride), the guest dye component used in the SMILES lattice can be identical to the calibration target (i.e., Rhodamine 6G chloride). In this circumstance, the absorption and emission properties in solution can be assumed to be reproduced in the resulting solid SMILES-derived calibrant. Compatibility with the SMILES lattice can be determined when the molecule can match the formula of the exemplary embodiment described above, and also sits within the electronic and structural windows of the SMILES lattice as described elsewhere in this disclosure.

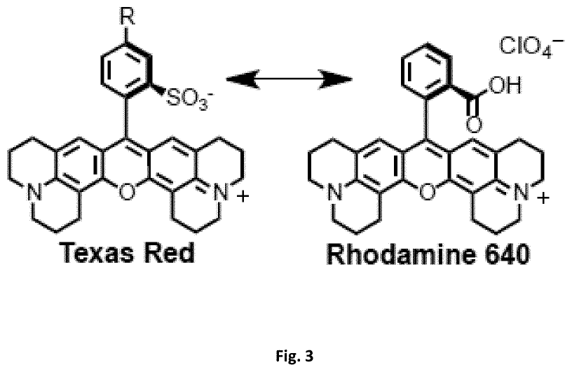

In other instances it can be common that the calibration target may not fit the compatibility requirements for the SMILES lattice, but a related compound may be used as a substitute. For example, Texas Red (also known as sulforhodamine 101) is a common molecular probe, but because it is zwitterionic (and therefore carries no charge) it could not be integrated into a SMILES lattice to create a calibrant. However, Rhodamine 640 perchlorate is a SMILES-compatible compound that is structurally similar to Texas Red (the sulfonates of Texas Red are substituted for a carboxylic acid in Rhodamine 640, see FIG. 3). In most cases, exchanging the substituents has only minor auxochromic effects on the spectral properties of the dyes, which are variations that can be compensated for at a later stage of formulation. In such a circumstance, the related SMILES-compatible compound will be selected as the guest dye.

When a target molecule is incompatible with the SMILES lattice and no closely related compound is available, the calibrant can be prepared from a compound that is compatible with the SMILES lattice that closely matches the spectral features of the target. For example, green fluorescent protein (GFP) is too large to fit within the SMILES structural window and no SMILES-compatible derivatives exist. However, its spectral properties (excitation=475 nm, emission=509 nm) are a close match for those of Basic Yellow 40, a benzimidazolium chloride salt (excitation=460 nm, emission=501 nm) that forms stable SMILES lattices with the anion receptor known as cyanostar. A GFP calibrant can be prepared from a SMILES lattice and any lingering differences between a target molecule and the SMILES-based calibrant candidate can be remediated with subsequent formulation.

There are circumstances where the calibration target can be a molecule or molecular system employing Forster resonance energy transfer (FRET) between two or more dyes. These systems are most commonly used in biological applications, and are typically not compatible with SMILES lattices as they are zwitterionic or too large to fit inside the SMILES structural window. Fortunately, SMILES composed of two or more dyes can provide efficient FRET behavior that can reproduce the desired optical properties of a calibration target. Dye choice for a SMILES-based FRET systems can be done by selecting a fluorescent dye molecule with an absorption band that matches the calibration target (donor) and a second dye with an emission band that matches the calibration target (acceptor). In some exemplary embodiments, the donor and acceptor dye components must both be the same type of ion (i.e., both must be cations or anions) although their charge states need not necessarily be equal (i.e., the donor could carry a +1 charge while the acceptor could carry a +2 charge). The final composition of an exemplary embodiment of a SMILES system can be a mixture of one or more dyes with a sufficient quantity of counterion receptor (generally two molar equivalents for each equivalent of dye). In one exemplary embodiment, the SMILES composition can include at least two dyes, a donor dye component and an acceptor dye component. The relative abundance of the dyes in this mixture can be adjusted to maximize the efficiency of the FRET process, with the ratio of donor:acceptor varying from between about 100:1 to 1:100 as desired. This approach to FRET systems may also be applied to calibration targets with unusually large Stokes shifts (>100 nm).

The quantity and composition of the counteranion receptors used to form an exemplary embodiment of a SMILES lattice can also a relevant consideration at the stage of initial dye component choice. In practice, the constituent parts of the SMILES calibrant can include a ratio of about one part dye component to about two parts receptor component with standard ion receptors (e.g., cyanostar for counteranions or crown ethers for countercations), or about one part dye component to about one part receptor component with receptors of added steric bulk (e.g., cyanosolo macrocycles), or about one part dye component to about three or more parts receptor component when larger counterions are used. In some exemplary embodiment, the proportion of receptor component relative to dye may be a range from about 0.1 to about 1000 as a way to tune optical properties or scavenge contaminant ionic materials in the host. The lattice may also include an optically inert receptor-counterion complexes as a means to increase inter-chromophore separation distance guest material. One exemplary embodiment can include a SMILES lattice composed of rhodamine 6G chloride and cyanostar (R6G⁺.CS₂(Cl⁻) may have tetrabutylammonium hexafluorophosphate-cyanostar complexes (TBA⁺.CS₂(PF₆⁻) added in a relative quantity of between about 0.1-1000 equivalents to mitigate inner filter effects.

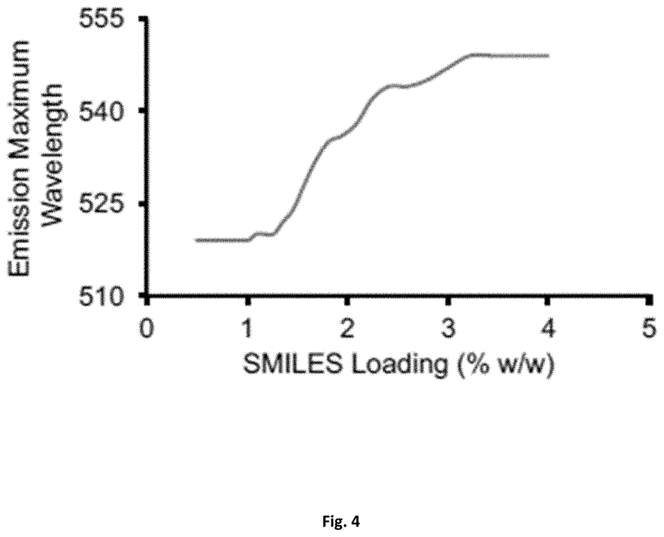

Once the fundamental optical properties of the calibrant have been established through the choice of fluorescent dye and SMILES lattice composition, fine adjustments to the optical properties can be made through a variety of means. These include the composition of the host material, the concentration of SMILES within the host material, the addition of exogenous dopants, the morphology of the final calibrant, and the method of integrating the SMILES lattice to produce the calibrant. The consequences of modifying these parameters is to tailor the optical properties of the SMILES lattice between conditions where the absorption and emission properties of the dye are maximally blue-shifted (resembling the optical properties of the dye in solvent at low concentrations) or maximally red-shifted (resembling the optical properties of a crystalline SMILES lattice). This tunability can extend over a significant spectral range. For example, increasing the concentration of SMILES based on the cyanine dye DIOC2 in a polymer lattice from between about 0.5% to about 4.0% (w/w) can red shift the emission maximum by as much as about 50 nm as shown in FIG. 4.

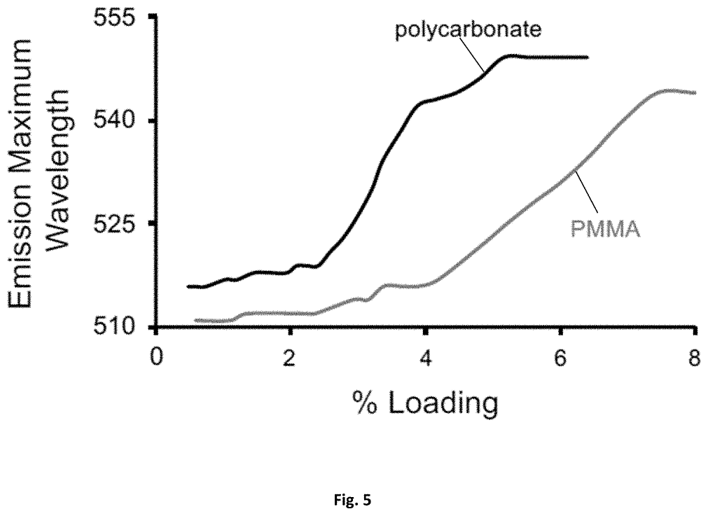

The composition of the host material plays an important role in realizing this tunability, with the behavior of SMILES in polymers as the foremost example. Polymers' solubilizing properties can be described using a metric known as the Hansen solubility parameter, with low-polarity polymers like polystyrene generally having poor solubilizing capabilities, and high-polarity polymers like poly(methylmethacrylate) (“PMMA”) having good solubilizing capabilities. In practice, this translates to tunable optical properties that span a larger concentration range in polymers with a higher solubility parameter as shown in FIG. 5. In addition, the polarity of the polymer can introduce a solvatochromic effect, where increased polymer polarity is associated with a hypsochromic shift in the absorption/emission spectra. In this way, the composition of a host material can compensate near-misses for desired optical properties. For example, SMILES derivatives of rhodamine 6G can show emission wavelengths as high as 602 nm when embodied as a pure solid, but can be blue-shifted to as low as 554 nm when dispersed in PMMA. Therefore, a rhodamine 6G SMILES calibrant would be suitable for calibration targets that fall anywhere within the 48 nm range between these extremes.

Moreover, the host material can be used to alter the transparency of the calibrant by way of its effect upon the SMILES guest. For example, owing to the strong solubilizing properties of PMMA or polyurethane, SMILES will be efficiently dispersed throughout the polymer, rendering a final product with high optical clarity. Conversely, polylactic acid (PLA) has a propensity to form crystalline domains that result in a spontaneous phase separation that excludes SMILES precursors. This in turn causes the formation of SMILES nano- and microparticles as they self-assemble outside the crystalline polymer domains, significantly reducing the transparency of the resulting calibrant. In circumstances where light scattering by the calibrant is desired, SMILES-polymer mixtures that result in low-transparency composites such as these would be desired; conversely in circumstances where light transmittance is required, a more strongly solubilizing polymer would be desirable.

The concentration of SMILES may also be used as a means to control a variety of optical properties in the calibrant including absorption/emission wavelength and emission intensity. Generally, higher concentrations of SMILES will show red-shifted optical properties as a result of trivial inner filter effects as well as increased emission intensities as a larger number of emitters are available in the sample.

Organic materials can be added to the calibrant as dopants as a means to further control optical properties. For example, organoiodine compounds (e.g., monoiodocyanostar (1)) may be added in small quantities to reduce the emission intensity by means of the heavy atom effect. Circularly polarized luminescence may be achieved through the introduction of chiral molecules to the SMILES lattice. Shaping of the absorption and emission bands can be achieved through the addition of tetrabutylammonium hexafluorophosphate-cyanostar complexes (TBA⁺.CS₂(PF₆⁻), which reduces the full width at half max as increasing quantities are added.

In addition, post-processing techniques familiar to those with training in the art may also be used to make additional modifications as needed. Examples include solvent vapor annealing, thermal annealing, surface polishing, application of protective coating or filter materials, and other techniques.

Finally, the ultimate morphology or form factor of the calibrant plays an important role. A SMILES-host composite may be embodied as films, polymer bulks, gels, particles, powders, suspensions, or solutions. In some exemplary embodiments, the SMILES composite can comprise between about 0.0001-100% of one or more SMILES elements and between about 0-99.9999% of one or more host elements. In some exemplary embodiments, the host composite can be a solid embodiment of “pure” SMILES material (e.g., crystal, microparticle, nanoparticle, film etc.), one or more solid host materials, such as polymers (including but not limited to polystyrene, polycarbonate, polyurethane etc.), gels (including but not limited to aqueous gels, organogels, sol gels, etc.), glasses, neat films, etc. deposited in or on a suitable solid substrate by mixing, compounding, spin coating, dip coating, or some similar process, or one or more liquid host materials, such as organic solvents (e.g., pentane, isopropanol, acetone, etc.) and aqueous solutions (including water, surfactant- and buffer-stabilized aqueous solutions and mixtures of water with soluble organic solvents).

The present disclosure also provides a method for calibrating light utilizing scientific instrumentation. One or more of the SMILES composite materials can be prepared for use as a calibrant (see Examples, below). Exemplary embodiments of the calibrant composites of the present disclosure can preserve the solution phase optical properties of fluorescent dyes in solid embodiments, (i.e., polymer matricies). The solution phase behavior of any fluorescent dye currently utilized in measurements in the solid-state is readily reproduceable and therefore provides calibrants for any instrument utilizing light technology. The SMILES composite can then be formed into a morphology suitable for the scientific instrument to be calibrated. In the case of hardware calibration, the sample can predictably fluoresce in response to illumination intensity allowing for the adjustment of instrument parameters (e.g., LED driving voltage, photodiode sensitivity, etc.). In the case of software calibration, the calibrant (or sequence of calibrants) can be used to generate an instrument response curve (emission intensity-concentration correlation) to determine if the instrument is operating efficiently and correctly set the software. Replicants of the designed SMILES calibrant can be manufactured on a large scale to allow for data comparison between instruments calibrated with SMILES.

### Example 1: Selecting SMILES Candidate Dye for SYBR Green Calibration Target

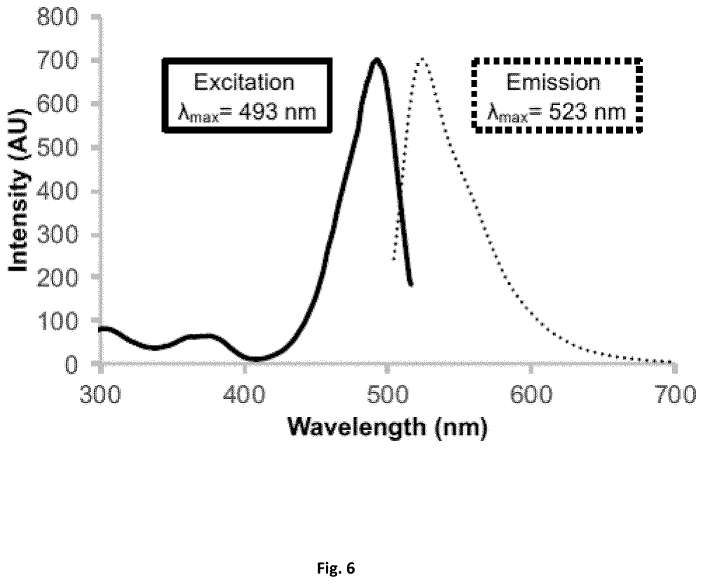

In one exemplary embodiment a solid-state calibrant can be designed for a calibration target such as SYBR Green, a standard fluorescent label used in biological assays. While SYBR Green is a charged dye and thus a potential guest in a SMILES lattice, it is too large to fit in a lattice comprised of the most suitable counterion receptor, cyanostar. No structural analogues to SYBR Green exist, and so a separate dye with suitable optical properties must be found. The absorption and emission spectra of SYBR Green are illustrated in FIG. 6 and the peak maxima (Abs/em=493 nm/523 nm) compared with a spectral database of SMILES materials. A close match is found in the form of cyanine hexafluorophosphate (DIOC2, Abs/em=499 nm/518 nm). This can serve as the basis for subsequent optimization.

### Example 2: Tuning of SMILES Optical Properties

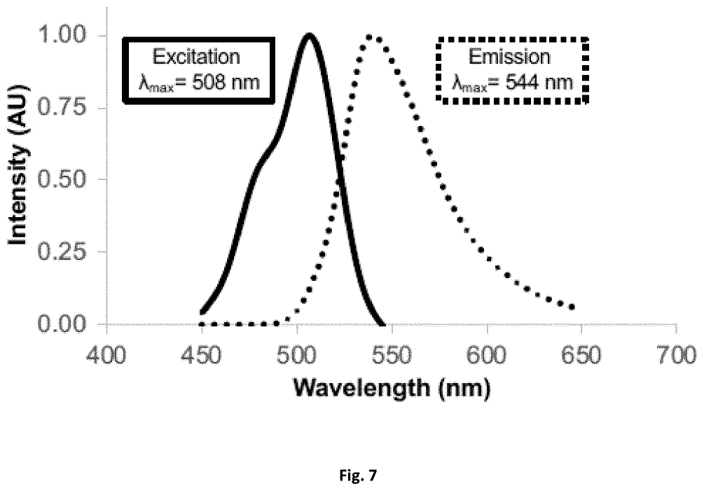

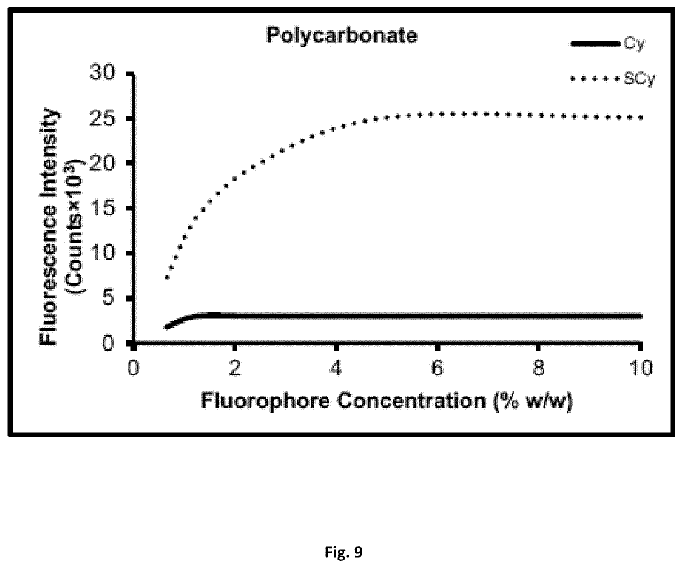

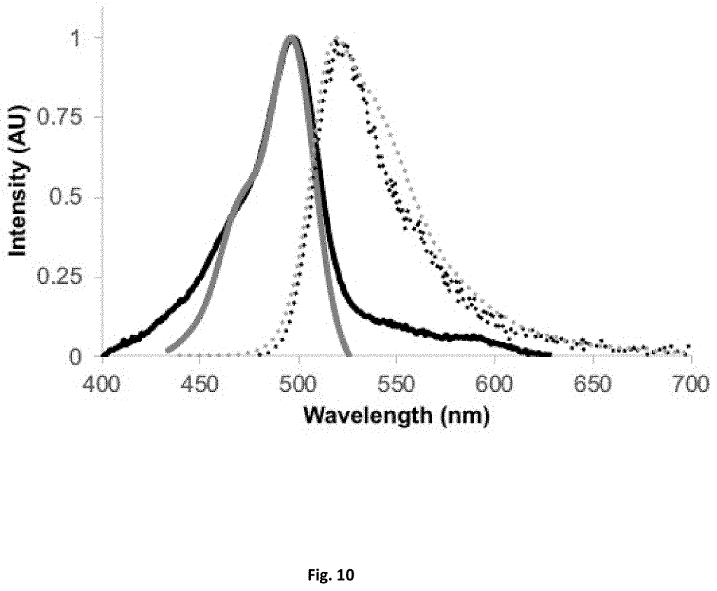

In some exemplary embodiments, when a cyanine is identified as the candidate, it can be incorporated into a solid host material and fabricated into a prototype calibrant for further optimization. In this exemplary circumstance, the final morphology of the calibrant can be a spin-coated thin film of SMILES-polymer composite deposited on a glass substrate by dropcasting. The stock solution to be used for dropcasting is made by dissolving the host polymer of interest at a suitable fraction in organic solvent (e.g., methylene chloride). The cyanine dye can then be added to this polymer solution at a specified concentration with respect to the polymer. The cyanostar anion receptor is then added in slight excess (2 equivalents of cyanostar per one equivalent of cyanine) to favor formation of the SMILES lattices while also scavenging unwanted ionic contaminants in either the solvent or the base polymer. The choice of host polymer is motivated by the known impact of the polymer on the guest optical properties. For instance, if the goal were to red-shift the optical properties, SMILES would be dropcast with a solution of polystyrene (1% polymer fraction in methylene chloride, 2.2% loading of SMILES with respect to polymer, w/w). This has the effect of shifting the absorbance and emission bands to longer wavelengths (FIG. 7, Abs/em=508 nm/544 nm). However, this outcome would be counterproductive given that the cyanine SMILES lattice needs to be blue-shifted to better approximate the SYBR Green calibration target. To this end, the SMILES-polymer composite will be reformulated to utilize polycarbonate, a more polar polymer that will move the absorption and emission bands to a shorter wavelength. A suitable dropcast solution for polycarbonate would contain about a 5% polymer fraction and about a 2% loading of SMILES with respect to the polymer. The resulting film shows absorption and emission maxima shifted to the desired wavelengths (Abs/em=493 nm/523 nm). The intensity of the emission can be adjusted by either increasing or decreasing the relative concentration of cyanine SMILES in the dropcasting solution with a compensatory modification to the polymer fraction if this concentration change results in wavelength shifts as a result of inner filter effects. This is a unique feature to SMILES that cannot be done using the dye alone (Compare Cy curve with sCy as shown in FIG. 9). Successful formulation of the calibrant can be determined by overlaying the spectra of the SYBR Green target and the corresponding SMILES calibrant (FIG. 10). The significant agreement between the two spectra indicates that the SMILES film is suitable as a calibrant for SYBR Green targets.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A method for calibrating light-based scientific instruments comprising:
establishing a calibration target;
providing a solid-state fluorescent calibration composite to reproduce the optical properties of the calibration target in a solid phase, wherein the solid state-fluorescent calibration composite comprises one or more of the following:
a small-molecule, ionic isolation lattices (“SMILES”) element; or
a host element.

2. The method of claim 1, wherein the solid-state fluorescent calibration composite further comprises both the SMILES element and the host element.

3. The method of claim 1, wherein the SMILES element is selected from a group of compounds having at least one of the following formulas:
(charged dye^{m+})ₓ.(counterionⁿ⁻)_{y}.(counterion receptor)_{z}, wherein the charged dye^{m+} is a cationic dye, the counterionⁿ⁻ is an anion, and the counterion receptor is a binding ligand for the counterionⁿ⁻. The values of m, n, x and y are integers greater than or equal to 1 and products of x.n and m.y are identical; or
(charged dye^{m-})ₓ.(counterionⁿ⁺)_{y}.(counterion receptor)_{z}, wherein the charged dye^{m-} is an anionic dye, the counterionⁿ⁺ is a cation, and counterion receptor is a binding ligand for counterionⁿ⁺. The m, n, x and y are integers greater than or equal to 1 and products of x.n and m.y are identical.

4. The solid-state fluorescent calibration composite of claim 3, wherein the host element comprise at least one of the following:
a solid host material; or
a liquid host material.

5. The method of claim 4, wherein the solid host material can be selected from one or more of the following:
polystyrene, polycarbonate, polyurethane, aqueous gels, organogels, sol gels, glasses, or neat films deposited in or on a substrate.

6. The method of claim 4, wherein the liquid host material can be selected from one or more of the following:
an organic solvents, water, surfactant- and buffer-stabilized aqueous solutions, or mixtures of water with soluble organic solvents.

7. The method of claim 4, wherein the charged dye is selected from the group consisting of the following:
include styryls, xanthenes, trianguleniums, oxazines, triarylmethanes, cyanines, acridines, fluoronones, phenanthridines, polyaromatic hydrocarbons, imides, BODIPYs, coumarins, and squaraines, or a combination thereof.

8. The method of claim 4, wherein the solid-state fluorescent calibration composite comprises a first charged dye and second charged dye.

9. The method of claim 4, wherein the counterion receptor is added in excess of the ion to favor formation of a SMILES lattice.

10. The method of claim 4, wherein charged dye is adjusted to maximize the efficiency of the Förster resonance energy transfer (FRET) process.

11. The method of claim 10, wherein the first charged dye has an absorption band that matches the calibration target and the second charged dye has an emission band that matches the calibration target.

12. The method of claim 11, wherein the with the ratio of first charged dye:second charged dye varying from between about 100:1 to 1:100.

13. The method of claim 4, wherein the solid-state fluorescent calibration composite includes a ratio of about one part charged dye component to about two parts receptor component.

14. The method of claim 4, wherein the solid-state fluorescent calibration composite includes a ratio of about one part charged dye component to about one part receptor component.

15. The method of claim 4, wherein the solid-state fluorescent calibration composite further comprises an optically inert receptor-counterion complex.

16. The method of claim 4, wherein the wherein the solid-state fluorescent calibration composite further comprises an exogenous dopant element.

17. A method for calibrating light utilizing scientific instrumentation comprising:
preparing a solid-state fluorescent calibration composite material for use as a calibrant;
providing the solid-state fluorescent calibration composite calibrant into a reservoir; and
generating a calibration curve to determine if the instrument is operating efficiently at a fluorescent point.

18. The method of claim 17, wherein the solid-state fluorescent calibration composite material comprises a small-molecule, ionic isolation lattices (“SMILES”) element and a host element.

19. The method of claim 18, wherein the SMILES element is selected from a group of compounds having at least one of the following formulas:
(charged dye^{m+})ₓ.(counterionⁿ⁻)_{y}.(counterion receptor)_{z}, wherein the charged dye^{m+} is a cationic dye, the counterionⁿ⁻ is an anion, and the counterion receptor is a binding ligand for the counterionⁿ⁻. The values of m, n, x and y are integers greater than or equal to 1 and products of x.n and m.y are identical; or
(charged dye^{m-})ₓ.(counterionⁿ⁺)_{y}.(counterion receptor)_{z}, wherein the charged dye^{m-} is an anionic dye, the counterionⁿ⁺ is a cation, and counterion receptor is a binding ligand for counterionⁿ⁺. The m, n, x and y are integers greater than or equal to 1 and products of x.n and m.y are identical.
